(19) United States
(12) Patent Application Publication
(10) Pub. No.: US 2024/0424534 A1
(43) Pub. Date: Dec. 26, 2024

(54) CLEANING FACILITY AND CLEANING METHOD FOR CLEANING A COMPONENT, PREFERABLY A VEHICLE BODY COMPONENT

(71) Applicant: Dürr Systems AG, Bietigheim-Bissingen (DE)

(72) Inventors: Jürgen Haas, Knittlingen (DE); Detlev Hannig, Winterbach (DE); Frank Herre, Oberriexingen (DE); Michael Baumann, Flein (DE); Harald Rasch, Stuttgart (DE); Thomas Irmscher, Bietigheim-Bissingen (DE)

(21) Appl. No.: 18/290,830

(22) PCT Filed: Jul. 1, 2022
(86) PCT No.: PCT/EP2022/068279

§ 371 Date: Jan. 22, 2024

(30) Foreign Application Priority Data
Jul. 23, 2021 (DE) 10 2021 119 185.8

(51) Int. Cl. B08B 1/20; B08B 1/12; B08B 1/16; B08B 1/34

(52) U.S. Cl. CPC B08B 1/20; B08B 1/12; B08B 1/16; B08B 1/34

(57) ABSTRACT

The disclosure relates to a cleaning installation for cleaning a component, preferably a motor vehicle body component, in particular laterally along a wet partial region of the component, with a cleaning station, a conveyor device for transporting the component through the cleaning station and a first cleaning apparatus for, preferably large area, cleaning the component. The cleaning installation is characterized in particular in that it comprises a multiaxial robot which comprises a second cleaning apparatus for, preferably sharp-edged, cleaning the component and which is adapted to guide the second cleaning apparatus laterally along a partial region of the component. The disclosure also comprises a corresponding cleaning method.

### CROSS-REFERENCE TO RELATED APPLICATIONS

This application is a national stage of, and claims priority to, Patent Cooperation Treaty Application No. PCT/EP2022/068279, filed on Jul. 1, 2022, which application claims priority to German Application No. DE 10 2021 119 185.8, filed on Jul. 23, 2021, which applications are hereby incorporated herein by reference in their entireties.

### FIELD

The disclosure relates to a cleaning installation and a cleaning method for cleaning a component, in particular a motor vehicle body component.

### BACKGROUND

A cleaning installation for cleaning motor vehicle body components is already known from DE 10 2009 020 114 A1. Such cleaning installations are usually used in order to, in painting installations for painting motor vehicle body components, clean the motor vehicle body components before the actual painting process, since the painting result could be impaired by contamination of the motor vehicle body components, for example by dust. In practice, in particular feather rollers (e.g. with emu feathers) and sword brushes have become established as particularly efficient cleaning apparatuses, because they are capable of cleaning thoroughly on the one hand and quickly on the other. However, in particular with feather rollers and sword brushes, sharp-edged cleaning is not possible or at least not satisfactorily, although this may be necessary, e.g., along not yet dried-out, wet seams of the component (e.g. sealing seams). If feather rollers or sword brushes get into not yet dried-out seams, this can lead to the cleaning apparatuses (e.g. feathers or bristles) and the components becoming contaminated and/or the seams being impaired. Sword brushes are also relatively expensive.

### BRIEF DESCRIPTION OF THE DRAWINGS

FIG. 1 shows a schematic view from above of a cleaning installation according to an embodiment of the disclosure,

FIG. 2 shows a schematic cross-sectional view of the cleaning installation, in particular on two automatic movement machines with respectively a first cleaning apparatus,

FIG. 3 shows another cross-sectional view of the cleaning installation, in particular on two multiaxial robots with respectively a second cleaning apparatus,

FIG. 4 shows a schematic view of an in particular wet partial region and a second cleaning apparatus,

FIG. 5 shows a schematic view of a first cleaning apparatus and a second cleaning apparatus according to an embodiment of the disclosure,

FIG. 6 illustrates a cleaning method according to an embodiment of the disclosure, and

FIG. 7 shows a schematic view from above of a cleaning installation according to another embodiment of the disclosure.

### DETAILED DESCRIPTION

An object of the disclosure is to provide a cleaning installation and a cleaning method for cleaning a component, in particular a motor vehicle body component, by means of which an in particular sharp-edged cleaning of the motor vehicle body component can be made possible, namely expediently laterally along a partial region of the component with in particular not yet dried-out surface.

The disclosure relates to a cleaning installation for cleaning a component, preferably a motor vehicle body component.

The cleaning installation serves in particular for cleaning the component laterally along a (in particular still) wet partial region of the component.

The cleaning installation comprises a cleaning station and a conveyor device for (e.g. continuously or successively) transporting the component through the cleaning station.

The cleaning installation also comprises at least one first cleaning apparatus for preferably large-area cleaning the component.

The first cleaning apparatus can, e.g., be part of an automatic movement machine as for example a multi-axis robot, a roof machine and/or a side machine, etc.

The cleaning installation is characterized in particular in that it comprises at least one multiaxial robot which comprises a second cleaning apparatus for preferably sharp-edged, in particular small-area cleaning the component, wherein the multiaxial robot is adapted in particular to guide the second cleaning apparatus laterally along a partial region of the component in order to advantageously clean the component laterally beside the partial region, preferably without the second cleaning apparatus entering the partial region.

The partial region of the component can, e.g., be a (particularly still) wet (e.g. moist) partial region and/or a partial region with not yet dried-out surface.

The partial region of the component can, e.g., be a seam (e.g. a sealing seam) with not yet dried-out surface, in particular a wet seam. Alternatively or additionally, the partial region of the component can be, e.g., a coating face with not yet dried-out surface.

The coating face can include, e.g., a paint face, a sealing face, an insulation face and/or a preservation face.

The coating face can include, e.g., polyvinyl chloride.

It is possible that the second cleaning apparatus is a cleaning brush, in particular a plastic cleaning brush.

The second cleaning apparatus can be, e.g., a cleaning roller (in particular a plastic cleaning roller), preferably having a roller outer diameter of, e.g., smaller than 40 cm, smaller than 35 cm, smaller than 32 cm or smaller than 29 cm and/or of, e.g., larger than 5 cm, larger than 10 cm, larger than 15 cm or larger than 20 cm.

In particular, the second cleaning apparatus can comprise, e.g., cleaning filaments for the advantageously sharp-edged cleaning, preferably a plurality of (expediently relatively long or relatively short) fibers, bristles and/or blades of preferably plastic (e.g., plastic fibers, plastic bristles and/or plastic blades). Alternatively or additionally, the second cleaning apparatus can comprise, e.g., a cleaning felt and can form, e.g., a cleaning felt roller.

E.g., the fibers, the bristles or the blades or in general the cleaning filaments can be in particular relatively short, e.g., maximum 3 cm, maximum 2 cm, maximum 1 cm or maximum 0.5 cm, but expediently also longer.

It is possible that the second cleaning apparatus (preferably formed as a cleaning roller) is provided with at least one lateral shielding device (e.g. a side wall or a limiting disk, etc.) to prevent the plastic fibers, plastic bristles or plastic blades or in general cleaning filaments from being deflected (e.g. deformed) beyond the shielding device laterally outward (e.g. into the partial region), e.g. if the plastic fibers, plastic bristles or plastic blades or in general the cleaning filaments are acted upon against the component during cleaning and could thereby be, e.g., deflected laterally. In this way, the sharp-edged cleaning can be advantageously supported and/or ensured.

It is possible that the second cleaning apparatus is expediently provided one-sided or both-sided with a lateral shielding device.

The shielding device can, e.g., consist of an elastically non-deformable or only minimally elastically deformable material.

It is possible that the multiaxial robot comprises at least 5 or at least 6 axes of movement and/or the second cleaning apparatus is mounted on a multiaxial robot hand.

It is possible that the first cleaning apparatus, in particular for large-area cleaning, is, e.g., a revolving sword brush, a feather brush, a feather roller, in particular an EMU feather roller, or a cleaning roller.

In an one embodiment, the first cleaning apparatus can be a first cleaning roller with a first roller outer diameter and the second cleaning apparatus can be a second cleaning roller with a second roller outer diameter, wherein the first roller outer diameter, preferably for large-area cleaning, can in particular be larger than the second roller outer diameter, preferably for sharp-edged, in particular small-area cleaning.

The first roller outer diameter can, e.g., be larger than the second roller out diameter by a factor of at least 1.5 or at least 2.0.

It is possible that the second cleaning apparatus is formed as a cleaning roller and comprises, e.g., a (expediently own) drive motor for rotating the cleaning roller. Alternatively or additionally, the first cleaning apparatus can preferably be formed as a cleaning roller and comprise, e.g., a (expediently own) drive motor for rotating the cleaning roller.

It is possible that, e.g., a drive rotational speed of the drive motor of the second cleaning apparatus is greater than, e.g., a drive rotational speed of the drive motor of the first cleaning apparatus, e.g. by a factor of at least 1.5, at least 2.0, at least 2.5 or at least 3.0.

E.g., a cleaning rotational speed of the second cleaning apparatus can preferably be greater than a cleaning rotational speed of the first cleaning apparatus by a factor of at least 1.5, at least 2.0, at least 2.5, or at least 3.0.

Consequently, the cleaning with the second cleaning apparatus can be performed with a cleaning rotational speed that is greater than the cleaning with the first cleaning apparatus (e.g., by a factor of at least 1.5, at least 2.0, at least 2.5, or at least 3.0).

It is possible that the cleaning installation, in addition to the multiaxial robot, expediently comprises at least one further automatic movement machine (with, e.g., at least one, at least 2, at least 3, at least 4, at least 5 or at least 6 axes of movement), which carries the first cleaning apparatus.

The first cleaning apparatus is thus preferably carried by its own automatic movement means, namely by the automatic movement machine, and the second cleaning apparatus is preferably carried by its own movement means, namely by the multiaxial robot.

The automatic movement machine can, e.g., be a multi-axis robot (e.g. with at least 4, at least 5 or at least 6 axes of movement) that is adapted to guide the first cleaning apparatus along the component, expediently in order to be able to clean the component.

However, the automatic movement machine can also include a so-called roof machine or side machine.

It is possible, e.g., that the cleaning installation for cleaning the component comprises at least one roof machine with preferably a first cleaning apparatus and/or a side machine with preferably a first cleaning apparatus.

The cleaning installation can, e.g., comprise on both sides of the conveyor device respectively at least one first cleaning apparatus as previously specified and/or respectively at least one second cleaning apparatus as previously specified.

The cleaning installation can thus comprise, e.g., on both sides of the conveyor device at least one automatic movement machine (e.g. multi-axis robot, side machine, etc.) with first cleaning apparatus and at least one multiaxial robot with second cleaning apparatus, and optionally, e.g., a roof machine with preferably a first cleaning apparatus.

It is possible that the multiaxial robot is adapted to guide the second cleaning apparatus laterally along the partial region, in particular without the second cleaning apparatus entering the partial region. Alternatively or additionally, the multiaxial robot can be adapted to guide the second cleaning apparatus laterally along the partial region with a lateral distance between the second cleaning apparatus and the partial region of less than 2 cm, less than 1 cm, less than 0.5 cm or less than 0.25 cm or with a lateral distance of substantially 0 cm.

It is understood that in the context of the disclosure, the first cleaning apparatus also cleans the component, in particular without the first cleaning apparatus entering the partial region. However, the first cleaning apparatus is configured for expediently large-area cleaning and thus is, e.g., not suitable for sharp-edged cleaning, so that the first cleaning apparatus can preferably only clean areas of the component that are expediently sufficiently far away from the partial region, e.g. at least 2 cm, at least 3 cm, at least 4 cm, at least 5 cm or at least 6 cm.

The first cleaning apparatus can therefore be particularly adapted to clean the component, namely e.g. with a lateral distance between the first cleaning apparatus and the partial region of at least 2 cm, at least 3 cm, at least 4 cm, at least 5 cm or at least 6 cm.

The cleaning installation can, e.g., comprise a control device for in particular automatically controlling the second cleaning apparatus (e.g., its rotational speed and/or its direction of rotation) and/or the multiaxial robot in order to guide the second cleaning apparatus laterally along the partial region.

It is thus possible, e.g, that the multiaxial robot is in particular adapted to and, by the control device expediently by means of control commands, controllable in order to guide the second cleaning apparatus laterally along the partial region.

The control device (e.g. control computing means, computer, etc.) can in particular be expediently connected to the multiaxial robot and comprise, e.g., a central control unit and/or a decentral control unit.

The control device can, e.g., comprise a control computing means on which a control program for controlling the multiaxial robot can be stored, in particular in order to guide the second cleaning apparatus expediently laterally along the partial region in a predefined manner.

It is possible within the scope of the disclosure, e.g., that the control device with its function is distributed over several different hardware components.

It should be mentioned that the cleaning of the component can be, e.g., an internal cleaning and/or an external cleaning of the component.

It should also be mentioned that the first cleaning apparatus serves in particular for area cleaning, e.g. for area cleaning of a roof and/or of one or more side parts of the component.

In particular, the first cleaning apparatus serves for cleaning the component with a lateral distance to the partial region.

The multiaxial robot for carrying the second cleaning apparatus is preferably smaller than a multi-axis robot for carrying the first cleaning apparatus.

The multiaxial robot and/or the multi-axis robot preferably comprises a plurality of pivotable robot arms, and can thus in particular be an articulated-arm robot.

The multiaxial robot is preferably arranged on a pedestal and/or the multi-axis robot is preferably arranged on a pedestal, wherein the pedestal of the multiaxial robot can, e.g., be higher than the pedestal of the multi-axis robot.

The cleaning station can comprise, e.g. inlet-sided and/or outlet-sided, a lock, in particular a sealing air portal.

The conveyor device can be formed, e.g., to transport the component from the cleaning station into a painting booth downstream of the cleaning station, wherein the painting booth can comprise, e.g. inlet-sided and/or outlet-sided, a lock.

The multiaxial robot with the second cleaning apparatus and the automatic movement machine with the first cleaning apparatus are preferably arranged in one and the same cleaning station.

It is possible that the multiaxial robot carries, e.g., only a single second cleaning apparatus and/or the automatic movement machine carries, e.g., only a single first cleaning apparatus.

The cleaning felt and/or the cleaning filaments of the second cleaning apparatus, as for example the plastic fibers, plastic bristles or plastic blades, expediently serve to clean the component in particular laterally along the partial region.

The designation “first” cleaning apparatus and “second” cleaning apparatus serves in particular to differentiate the cleaning apparatuses and, e.g., not to define the order of their arrangement. It is thus possible, e.g., that the second cleaning apparatus and/or the multiaxial robot can be arranged relative to the conveying/transport direction of the component, e.g., before or after the first cleaning apparatus and/or the automatic movement machine.

The disclosure also comprises a cleaning method for cleaning a component, preferably a motor vehicle body component, in particular carried out with a cleaning installation as disclosed herein, so that the disclosure regarding the cleaning installation expediently also applies to the cleaning method.

The cleaning method serves in particular for cleaning the component laterally along a (particularly still) wet partial region of the component.

The cleaning method comprises in particular following:
transporting the component by means of a conveyor device through a cleaning station,
cleaning, preferably large-area cleaning, of the component by means of a first cleaning apparatus, and
cleaning, preferably sharp-edged cleaning, in particular small-area cleaning, of the component by means of a second cleaning apparatus which is guided laterally along a partial region of the component by means of a multiaxial robot in order to clean the component laterally beside the partial region.

The sequence of the method operations in the claims can, e.g., but expediently need not define the sequence of the method.

Thus, e.g., the large-area cleaning (area cleaning) can be carried out first and then the sharp-edged, in particular small-area cleaning (fine cleaning), or vice versa, wherein alternatively or additionally the large-area cleaning and the sharp-edged, in particular small-area cleaning can also be carried out simultaneously, e.g. at least at times.

Cleaning with the second cleaning apparatus can be carried out, e.g., with a higher cleaning rotational speed than cleaning with the first cleaning apparatus (e.g., by a factor of at least 1.5, at least 2.0, at least 2.5 or at least 3.0).

It is possible, e.g., that the cleaning of the component by means of the second cleaning apparatus takes place at least at times simultaneously with the cleaning by means of the first cleaning apparatus.

Alternatively or additionally, the cleaning of the component by means of the second cleaning apparatus can take place at least at times temporally before and/or at least at times temporally after the cleaning by means of the first cleaning apparatus.

It is possible that a wet partial region is applied to the component temporally before the cleaning method and/or the component is coated temporally after the cleaning method.

The embodiments of the disclosure described with reference to the figures coincide in part, wherein similar or identical parts are indicated by the same reference signs, and reference can also be made to the description of the other embodiments for their explanation in order to avoid repetitions.

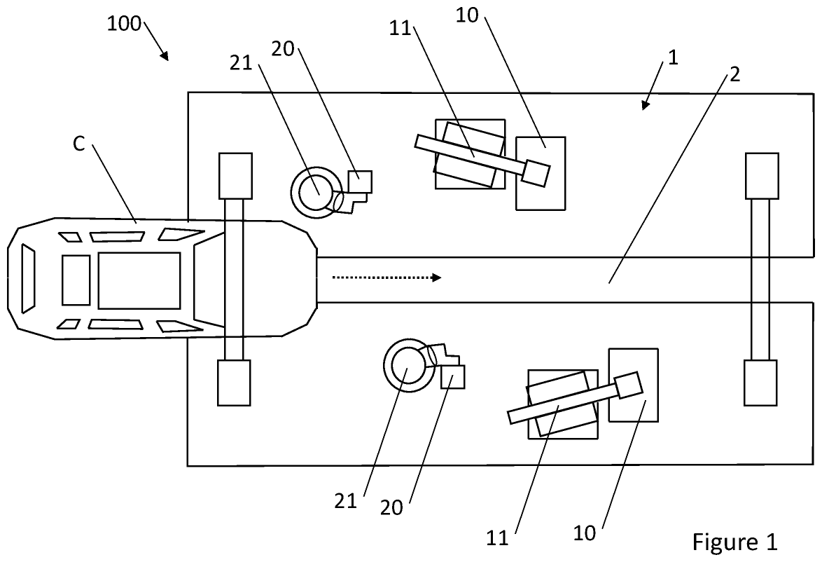

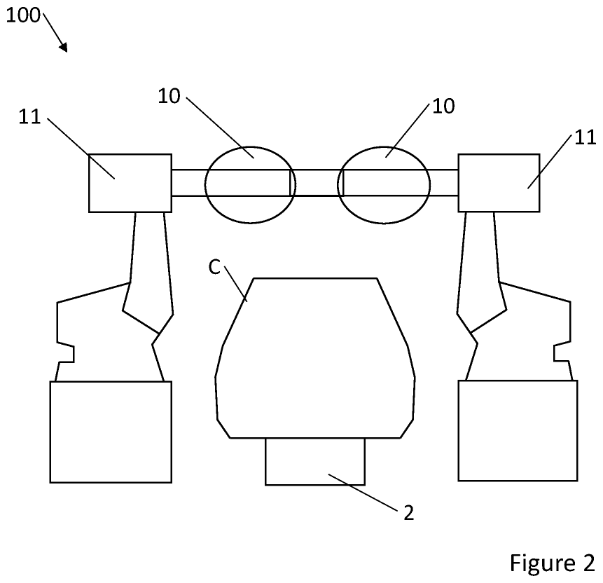

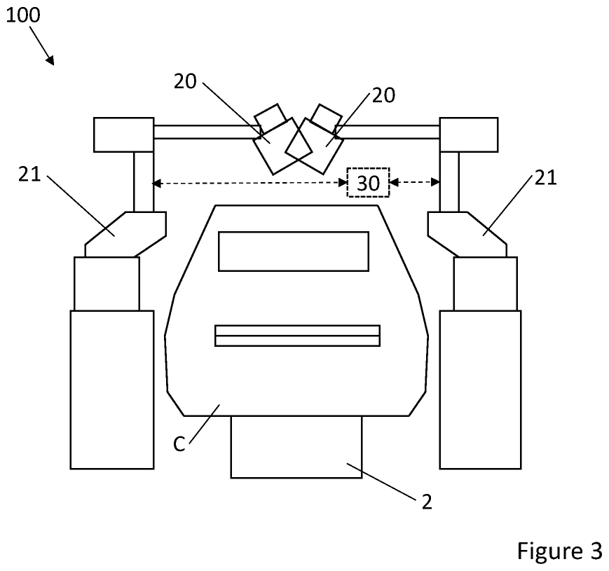

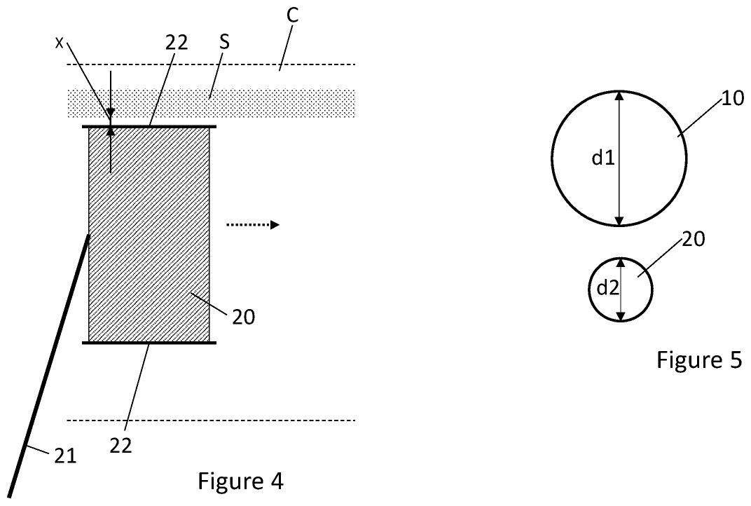

FIGS. 1 to 3 show different views of a cleaning installation 100 for cleaning a component C, in particular a motor vehicle body component. The cleaning installation 100 servers in particular for cleaning the component C laterally along a still wet partial region S of the component C (cf. FIG. 4).

The cleaning installation 100 comprises a cleaning station 1 and a conveyor device 2 for in particular linearly transporting the component C through the cleaning station 1, wherein in FIG. 1 the dotted arrow indicates the conveying/transport direction of the component C through the cleaning station 1. The cleaning station 1 can comprise, inlet-sided and/or outlet-sided, e.g. a lock.

In the direction of the arrow before the cleaning station 1, the component C can be provided with a wet partial region S (cf. FIG. 4), wherein the wet partial region S can comprise, e.g., a seam, in particular a sealing seam such as a PVC seam. In the direction of the arrow after the cleaning station 1, e.g., a dip painting station and/or one or more painting booths can be arranged in which the component C can be painted after cleaning. However, the wet partial region S is not limited to seams, but can also comprise, e.g., generally coating faces, as for example paint, sealing, insulating or preservation faces, which can be applied to the component C in the direction of the arrow before the cleaning station 1.

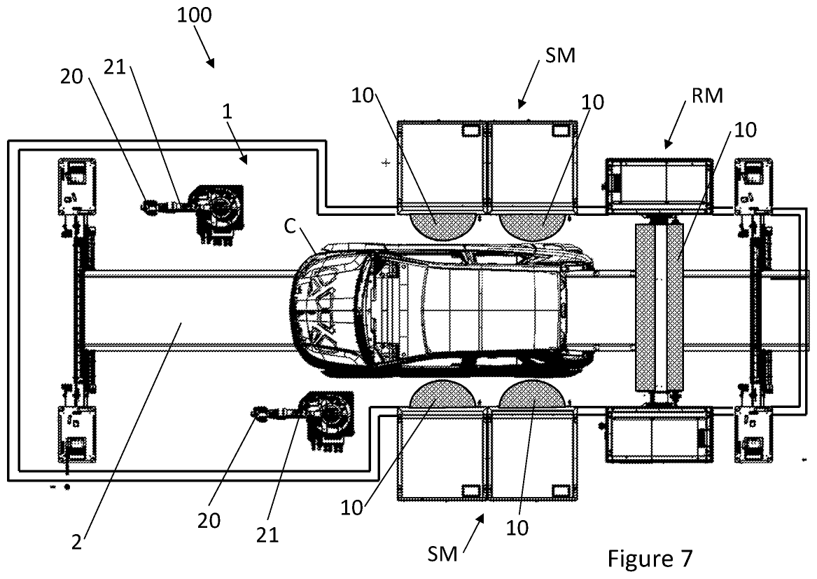

The cleaning installation 100 comprises, on one side of the conveyor device 2, an automatic movement machine 11, preferably formed as a multi-axis robot (with, e.g., at least 5 or at least 6 axes of movement), which carries a first cleaning apparatus 10 for large-area cleaning of the component C. The cleaning apparatus 10 can be, e.g., a revolving sword brush, a feather brush, a feather roller or a cleaning roller. Preferably, however, the first cleaning apparatus 10 is an emu feather roller. The same arrangement can expediently be provided on the other side of the conveyor device 2. However, the automatic movement machine 11 can also be formed, e.g., as a roof or side machine (cf. FIG. 7).

The cleaning installation 100 comprises, in addition to the automatic movement machine 11, a multiaxial robot 21 (with, e.g., at least 5 or at least 6 axes of movement), which carries a second cleaning apparatus 20 for sharp-edged, expediently small-area cleaning of the component C. The second cleaning apparatus 20 can be mounted, e.g., on a multiaxial robot hand. The same arrangement can expediently be provided on the other side of the conveyor device 2.

The first cleaning apparatus 10 serves for large-area cleaning of the component C, e.g. for cleaning the roof and/or one or more side parts of the component C.

The second cleaning apparatus 20 serves for sharp-edged, small-area and in particular precise cleaning of the component C laterally along the predefined partial region S.

It is possible that the multiaxial robot 21 and/or the second cleaning apparatus 20 is, as in FIG. 1, arranged relative to the conveying direction of the component C before the first automatic movement machine 11 and/or before the first cleaning apparatus 10. However, in the context of the disclosure, embodiments are also possible in which the multiaxial robot 21 and/or the second cleaning apparatus 20 is arranged relative to the conveying direction of the component C, e.g., after the first automatic movement machine 11 and/or after the first cleaning apparatus 10.

The multiaxial robot 21 with the second cleaning apparatus 20 is expediently arranged in the same cleaning station 1 as the automatic movement machine 11 with the first cleaning apparatus 10. However, embodiments are also possible in which the multiaxial robot 21 with the second cleaning apparatus 20 and the first cleaning apparatus 10 preferably with the automatic movement machine 11 are arranged in different cleaning stations.

As can be seen in particular from the schematic FIG. 4, the robot 21 is adapted to guide the second cleaning apparatus 20 along the dotted arrow direction in FIG. 4 laterally along a particularly still wet partial region S of the component C, so that the component C can be cleaned laterally beside the partial region S. The second cleaning apparatus 20 is preferably a (in particular relatively small) plastic roller.

The partial region S can in particular be a seam (e.g. sealing seam, in particular PVC seam) with a surface that has not yet dried-out and/or a coating face (e.g. paint, insulation, sealing or preservation face) with a surface that has not yet dried-out.

Preferred objective is to keep a lateral distance x between the second cleaning apparatus 20 and the still wet partial region S as small as possible, but to prevent the second cleaning apparatus 20 from entering the partial region S. If the second cleaning apparatus 20 enters the still wet partial region S, the second cleaning apparatus 20 and the component C can become soiled, while the partial region S itself can be damaged.

The robot 21 is therefore particularly adapted to guide the second cleaning apparatus 20 laterally along the partial region S, namely without the second cleaning apparatus 20 entering the still wet partial region S, but the component C is nevertheless cleaned as far as possible towards the partial region S, e.g. with a lateral distance x between the second cleaning apparatus 20 and the partial region S of less than e.g. 0.5 cm or even with a lateral distance x of substantially 0 cm.

Thus, although the partial region S has not yet dried-out and is thus still wet, the component C can nevertheless also be cleaned laterally along the partial region S. Thus, there is no need to wait for the partial region S to dry-out in order to clean the component C.

The second cleaning device 20 can optionally be provided with at least one lateral shielding device 22 (e.g., a side wall or a limiting disk) shown schematically in FIG. 4 in order to, in particular for sharp-edged cleaning, substantially prevent cleaning filaments of the second cleaning device 20, as for example plastic fibers, plastic bristles or plastic sheets, from being deflected (e.g., deformed) beyond the shielding device 22 laterally outward, e.g., into the partial region S, e.g., if the cleaning filaments are acted upon against the component C during cleaning and are thereby, e.g. deflected laterally. The second cleaning device 20 can comprise, one-sided or both-sided, the shielding device 22. The shielding device 22 can, e.g., consist of an elastically non-deformable or only minimally elastically deformable material.

It is understood that the first cleaning apparatus 10 is also guided along the component C in such a way that it does not enter the partial region S. However, the first cleaning apparatus 10 is expediently formed for large-area cleaning and is thus in particular not suitable for sharp-edged cleaning, so that the first cleaning apparatus 10 can preferably only clean areas of the component that are sufficiently far away from the partial region S.

The cleaning installation 100 can, e.g., comprise a control device 30 (e.g. control computing means, computer, etc.) shown only schematically, on which, e.g., a control program for controlling the robot 21 and/or the second cleaning apparatus 20 can be stored. It is possible that the robot 21 on one side of the conveyor device 2 and/or the robot 21 on the other side of the conveyor device 2 is controllable by the control device 30 to guide the second cleaning apparatus 20 laterally along the partial region S as previously explained. However, it is alternatively or additionally also possible that the both robots 21 are controlled by different control devices. The same applies expediently to the second cleaning apparatus 20.

In the explained embodiment, preferably the first cleaning apparatus 10 is a cleaning roller with a first roller outer diameter d1 and the second cleaning apparatus 20 is a cleaning roller, in particular a plastic cleaning roller, with a second roller outer diameter d2, wherein the first roller outer diameter d1 is larger than the second roller outer diameter d2, which is shown schematically in, e.g., FIG. 5.

The first roller outer diameter d1 can be larger than the second roller outer diameter d2, e.g., by at least a factor of 1.5 or at least a factor of 2.0.

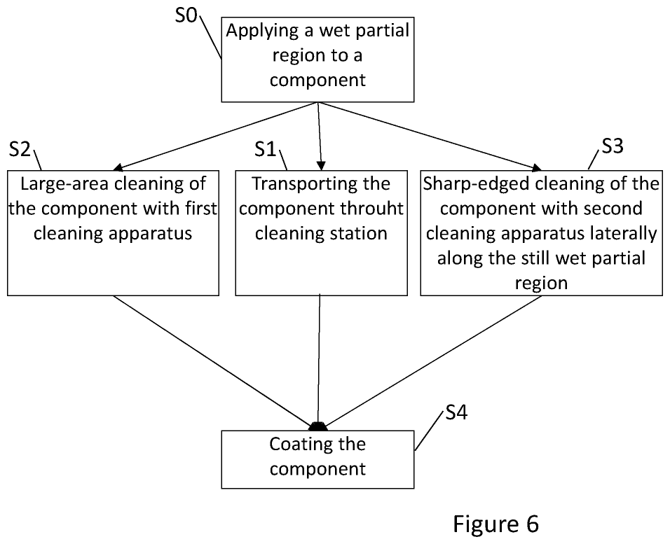

FIG. 6 illustrates a cleaning method according to an embodiment of the disclosure, wherein the cleaning method can be carried out with a cleaning installation 100 as disclosed herein.

In a step S0, the wet partial region S can be applied to the component C, namely temporally before the cleaning method is carried out.

In a step S1, the component C can be transported through the cleaning station 1 by means of the conveyor device 2.

In a step S2, a preferably large-area cleaning of the component C can be carried out by means of the first cleaning apparatus 10.

In a step S3, a sharp-edged, in particular small-area cleaning of the component C can be carried out by means of the second cleaning apparatus 20, which is guided by means of the multiaxial robot 21 laterally along the still wet partial region S of the component C in order to clean the component C laterally beside the still wet partial region S.

In a step S4, the component C can be coated, e.g. by paint, temporally after the cleaning method.

Steps S1, S2 and/or S3 can be carried out at least at times simultaneously and/or at least at times consecutively. Step S3 can be carried out, e.g., at least at times temporally before step S3 or vice versa.

Cleaning with the second cleaning apparatus 20 is preferably performed with a (e.g., by a factor of at least 1.5, at least 2.0, or at least 2.5) greater cleaning rotational speed than cleaning with the first cleaning apparatus 10.

The sequence of the method in the claims can, e.g., but need not necessarily define the sequence of the method.

FIG. 7 shows a cleaning installation 100 according to another embodiment of the disclosure.

A feature is that the cleaning installation 100 comprises in particular for large-area cleaning of the component C a roof machine RM with a first cleaning apparatus 10 and comprises, on preferably both sides of the conveyor device 2, a side machine SM with a first cleaning apparatus 10. The cleaning apparatuses 10 of the roof machine RM and of the side machine SM can be the same or different, but in any case serve for in particular large-area cleaning of the component C.

The disclosure is not limited to the preferred embodiments described above. Rather, a large number of variants and modifications are possible which also make use of the idea of the disclosure and therefore fall within the scope of protection. In addition, the disclosure also claims protection for the subject matter and the features of the sub-claims independently of the referenced features and claims.

1.-26. (canceled)

27. A cleaning device for cleaning a motor vehicle body component, in particular laterally along a wet partial region of the component, comprising:
a cleaning station,
a conveyor device for transporting the component through the cleaning station, and
a first cleaning apparatus for, preferably large-area, cleaning the component, characterized in that
the cleaning device comprises a multiaxial robot which carries a second cleaning apparatus for, preferably sharp-edged, cleaning the component and which is adapted to guide the second cleaning apparatus laterally along a partial region of the component.

28. The cleaning device according to claim 27, wherein the partial region is a wet partial region and/or a partial region with not yet dried-out surface.

29. The cleaning device according to claim 27 wherein the partial region is a seam with not yet dried-out surface and/or a coating face with not yet dried-out surface.

30. The cleaning device according to claim 27 wherein in that the second cleaning apparatus is a cleaning brush, in particular a plastic cleaning brush.

31. The cleaning device according to claim 30 wherein the second cleaning apparatus is a cleaning roller, in particular a plastic cleaning roller.

32. The cleaning device according to claim 31 wherein the cleaning roller has a roller outer diameter of less than 35 cm, less than 32 cm or less than 29 cm and of greater than 10 cm.

33. The cleaning device according to claim 27 wherein the second cleaning apparatus comprises a cleaning felt, plastic fibers, plastic bristles or plastic blades.

34. The cleaning device according to claim 27 wherein the multiaxial robot comprises at least 5 or at least 6 axes of movement and/or the second cleaning apparatus is mounted on a multiaxial robot hand.

35. The cleaning device according to claim 34 wherein the first cleaning apparatus is a sword brush, a feather brush, a feather roller, in particular an emu feather roller, or a cleaning roller.

36. The cleaning device according to claim 34 wherein the first cleaning apparatus is a cleaning roller with a first roller outer diameter and the second cleaning apparatus is a cleaning roller with a second roller outer diameter and the first roller outer diameter is larger than the second roller outer diameter, preferably by a factor of at least 1.5 or at least 2.0.

37. The cleaning device according to claim 34 wherein the cleaning device comprises, in addition to the multiaxial robot, an automatic movement machine which carries the first cleaning apparatus.

38. The cleaning device according to claim 37 wherein the automatic movement machine comprises a multi-axis robot adapted to move the first cleaning apparatus along the component.

39. The cleaning device according to claim 34 wherein the cleaning device comprises on both sides of the conveyor device respectively at least one first cleaning apparatus and/or respectively at least one second cleaning apparatus.

40. The cleaning device according to claim 34 wherein the multiaxial robot is adapted to guide the second cleaning apparatus laterally along the partial region,
without the second cleaning apparatus entering the partial region and/or
with a lateral distance between the second cleaning apparatus and the partial region of less than 0.5 cm or less than 0.25 cm or substantially 0 cm.

41. The cleaning device according to claim 33 wherein the second cleaning apparatus is provided with at least one lateral shielding device to prevent the cleaning felt, the plastic fibers, plastic bristles or plastic blades from being deflected beyond the shielding device laterally outward, e.g. into the partial region.

42. The cleaning device according to claim 27 wherein the cleaning device comprises a control device for controlling the second cleaning apparatus and/or for controlling the multiaxial robot in order to guide the second cleaning apparatus laterally along the partial region.

43. The cleaning device according claim 27 wherein the automatic movement machine is adapted to guide the first cleaning apparatus along the component, with a lateral distance to the partial region and without the first cleaning apparatus entering the partial region.

44. The cleaning device according to claim 34 wherein the multiaxial robot carries only a single second cleaning apparatus and/or the automatic movement machine carries only a single first cleaning apparatus.
